(19) United States
(12) Patent Application Publication
(10) Pub. No.: US 2025/0274788 A1
(43) Pub. Date: Aug. 28, 2025

(54) CORE NETWORK MONITORING METHOD AND SYSTEM

(71) Applicants: INVENTEC (PUDONG) TECHNOLOGY CORPORATION, Shanghai (CN); INVENTEC CORPORATION, Taipei City (TW)

(72) Inventors: Chin Hsuan CHIANG, Taipei City (TW); Ke-Hao CHEN, Taipei City (TW); Ya Sheng CHANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/742,920

(22) Filed: Jun. 13, 2024

(30) Foreign Application Priority Data
Feb. 27, 2024 (CN) 202410218085.4

(51) Int. Cl. H04W 24/06; H04W 52/02

(52) U.S. Cl. CPC H04W 24/06; H04W 52/0206

(57) ABSTRACT

A core network monitoring method, performed by a processing device, includes: detecting a connection condition of a main core network, outputting a first control signal to a base station connected to the main core network and timing a time length when determining that the main core network is disconnected according to the connection condition, wherein the first control signal indicates lowering antenna radiated power of the base station, and outputting a second control signal to the base station when the time length is equal to or greater than a default time length, wherein the second control signal indicates increasing the antenna radiated power.

### CROSS-REFERENCE TO RELATED APPLICATIONS

This non-provisional application claims priority under 35 U.S.C. § 119 (a) on Patent Application No(s). 202410218085.4 filed in China on Feb. 27, 2024, the entire contents of which are hereby incorporated by reference.

### BACKGROUND

### 1. Technical Field

This disclosure relates to a core network monitoring method and system.

### 2. Related Art

In the existing 5G standalone (SA) structure, when there is a failure in the core network and thus requiring the transfer of connections of user devices, the base station must automatically switch connections to another core network, and the user devices must re-register to restore connections.

However, when there is a core network failure, connected user device is unable to receive notifications and is unable to quickly react to reconnect, and can only passively rely on the self-check mechanism of the user device. Moreover, if the cycle time of the user device's self-check mechanism is long, it significantly affects the reconnection time of the user device, leading to prolonged network interruption in 5G end-to-end applications.

### SUMMARY

Accordingly, this disclosure provides a core network monitoring method and system.

According to one or more embodiment of this disclosure, a core network monitoring method, performed by a processing device, includes: detecting a connection status of a main core network; outputting a first control signal to a base station connected to the main core network and starting timing a duration when determining that the main core network is disconnected according to the connection status of the main core network, wherein the first control signal indicates lowering an antenna radiated power of the base station; and outputting a second control signal to the base station when the duration is equal to or longer than a default duration, wherein the second control signal indicates increasing the antenna radiated power.

According to one or more embodiment of this disclosure, a core network monitoring system includes: a main core network, a base station and a processing device. The base station includes an antenna and is connected to the main core network. The processing device is connected to the main core network and the base station, the processing device is configured to detect a connection status of the main core network, output a first control signal to the base station and start timing a duration when determining that the main core network is disconnected according to the connection status of the main core network, and output a second control signal to the base station when the duration is equal to or longer than a default duration, wherein the first control signal indicates lowering an antenna radiated power of the antenna, and the second control signal indicates increasing the antenna radiated power.

In view of the above description, through the core network monitoring method and system according to one or more embodiments of the present disclosure, when the main core network experiences a failure, the base station may be triggered to lower antenna radiated power and, after the default duration, increase the antenna radiated power to actively and swiftly respond to the user equipment. This allows for quick triggering of the user equipment to reconnect to the core network, thereby improving the efficiency of overall end-to-end network fault recovery. Further, by using a buffering mechanism of the default duration, the probability of misjudgment by the user equipment may be reduced.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a core network monitoring system according to an embodiment of the present disclosure;

FIG. 2 is a flow chart illustrating a core network monitoring method according to an embodiment of the present disclosure; and

FIG. 3 is a flow chart illustrating detecting a connection status of a main core network according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

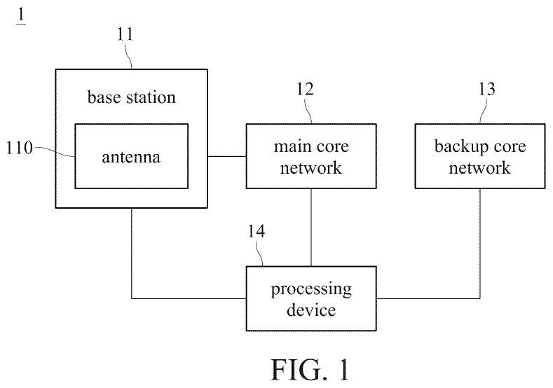

Please refer to FIG. 1, wherein FIG. 1 is a block diagram illustrating a core network monitoring system according to an embodiment of the present disclosure. As shown in FIG. 1, the core network monitoring system 1 includes a base station 11, a main core network 12, a backup core network 13 and a processing device 14. The processing device 14 is connected to the base station 11, the main core network 12 and the backup core network 13.

The base station 11 includes an antenna 110 and is connected to the main core network 12. The base station 11 may include a 5G base station. The base station 11 may be configured to receive packet from user equipment (UE), and the main core network 12 outputs the packet to a data network. The user equipment may include mobile terminal equipment and fixed terminal equipment. Further, the mobile terminal equipment may include 5G mobile phone and automated guided vehicle (AGV) etc. that support standalone (SA) networking; and the fixed terminal equipment may include 5G customer premise equipment (CPE) router etc. that supports standalone (SA) networking, the present disclosure is not limited thereto.

The main core network 12 and the backup core network 13 may each include access and mobility management function (AMF), session management function (SMF), authentication server function (AUSF), unified data management (UDM) and user plane function (UPF) etc. The AMF function is responsible for managing accessibility and mobility of 5G device, and providing registration, authentication, permission and other services for the user equipment during access after connecting to the base station.

The processing device 14 is configured to control the antenna radiated power of the antenna 110 according to the connection status of the main core network 12. The processing device 14 may include one or more processors, wherein the processor is, for example, a central processing unit (CPU), a graphics processing unit (GPU), a microcontroller, a programmable logic controller, or other processors with signal processing capabilities. Further, the processing device 14 may be a processing device included in the base station 11 or a processing device at network management platform end (for example, service management and orchestration (SMO)) platform.

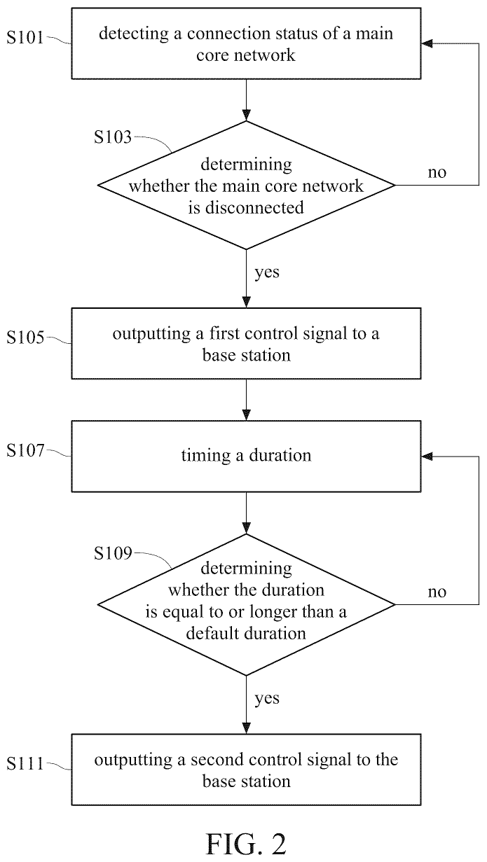

Please refer to FIG. 1 and FIG. 2, wherein FIG. 2 is a flow chart illustrating a core network monitoring method according to an embodiment of the present disclosure. As shown in FIG. 2, the core network monitoring method includes: step S101: detecting a connection status of a main core network; step S103: determining whether the main core network is disconnected; when the determination result of step S103 is “no”, performing step S101 again; when the determination result of step S103 is “yes”, performing step S105: outputting a first control signal to a base station; step S107: timing a duration; step S109: determining whether the duration is equal to or longer than a default duration; when the determination result of step S109 is “no”, performing step S107 again; and when the determination result of step S109 is “yes”, performing step S111: outputting a second control signal to the base station.

In step S101, the processing device 14 may use automatic mechanism (such as application, commands or script etc.) to detect the connection status of the main core network 12. The processing device 14 may use the connection status between the main core network 12 and the base station 11 as the connection status of the main core network 12. For example, the processing device 14 may use the connection status of AMF of the main core network 12 as the connection status of the main core network 12. In step S103, the processing device 14 determines whether the main core network 12 is disconnected according to the connection status of the main core network 12. When the processing device 14 determines that the main core network 12 is not disconnected, the processing device 14 may perform step S101 again to continue monitoring the connection status of the main core network 12.

When the processing device 14 determines that the main core network 12 is disconnected, in step S105, the processing device 14 outputs the first control signal to the base station 11 connected to the main core network 12, wherein the first control signal indicates lowering the antenna radiated power of the antenna 110 of the base station 11. Further, said lowering the antenna radiated power of the antenna 110 of the base station 11 may be lowering the antenna radiated power to a default lower limit, or may be turning off the antenna 110 of the base station 11 directly. By lowering the antenna radiated power of the antenna 110 of the base station 11, the user equipment and the base station 11 may be forced to disconnect from each other.

In step S107, the processing device 14 times the duration that the antenna radiated power is lowered (or the duration that the antenna 110 is turned off), wherein an initial value of the duration may be 0. The processing device 14 may start timing the duration at the same time of outputting the first control signal.

In step S109, the processing device 14 determines whether the duration is equal to or longer than the default duration, wherein the default duration is, for example, 5 seconds to 10 seconds, but the present disclosure is not limited thereto. When the processing device 14 determines that the duration is not equal to and is not longer than the default duration, the processing device 14 may perform step S107 again to continue timing the duration.

When the processing device 14 determines that the duration is equal to or is longer than the default duration, in step S111, the processing device 14 outputs the second control signal to the base station 11, wherein the second control signal indicates increasing the antenna radiated power of the antenna 110 of the base station 11. Further, the second control signal may include an instruction of increasing the antenna radiated power to a power value of normal operation, an instruction of activating the antenna 110, or an instruction of connecting the base station 11 to the backup core network 13 (for example, connecting the base station 11 to the AMF element of the backup core network 13). Accordingly, through the control of the second control signal, the user equipment may be forced to automatically reconnect to the main core network 12 or the backup core network 13. Additionally, connecting the base station 11 to the backup core network 13 may effectively reduce the time for the user equipment to reconnect to the core network, thereby improving the efficiency of overall end-to-end network fault recovery.

When the time difference between the antenna being turned off and turned on is too short, it may cause the user equipment to misjudge the normal operation of the main core network, leading to ineffective disconnection of the user equipment. Therefore, by using a buffering mechanism of the default duration, the probability of misjudgment by the user equipment may be reduced.

Through the core network monitoring method and system according to one or more embodiments of the present disclosure, when the main core network experiences a failure, the base station may be triggered to lower antenna radiated power and, after the default duration, increase the antenna radiated power to actively and swiftly respond to the user equipment. This allows for quick triggering of the user equipment to reconnect to the core network, thereby improving the efficiency of overall end-to-end network fault recovery.

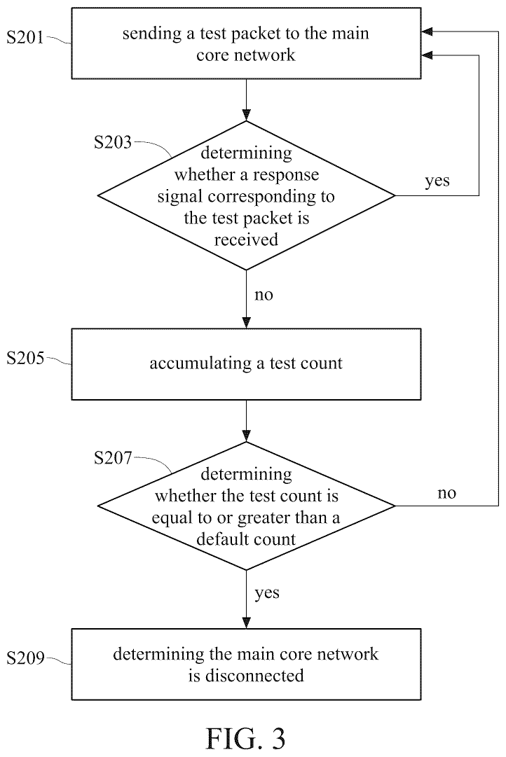

Please refer to FIG. 1 and FIG. 3, wherein FIG. 3 is a flow chart illustrating detecting a connection status of a main core network according to an embodiment of the present disclosure. FIG. 3 may be regarded as a detailed flow chart of an embodiment of step S101 of FIG. 2. As shown in FIG. 3, detecting the connection status of the main core network 12 includes: step S201: sending a test packet to the main core network; step S203: determining whether a response signal corresponding to the test packet is received; when the determination result of step S203 is “yes”, performing step S201 again; when the determination result of step S203 is “no”, performing step S205: accumulating a test count; step S207: determining whether the test count is equal to or greater than a default count; when the determination result of step S207 is “no”, performing step S201 again; and when the determination result of step S207 is “yes”, performing step S209: determining the main core network is disconnected. Steps S201, S203, S205 and S207 may be regarded as a test procedure.

In step S201, the processing device 14 sends the test packet to the main core network 12. For example, the processing device 14 may send the test packet to the AMF element of the main core network 12. The test packet may include address(es) etc. of the processing device 14 and/or the main core network 12, the present disclosure does not limit the specific content of the test packet.

In step S203, the processing device 14 determines whether the response signal corresponding to the test packet is received from the main core network 12, wherein the response signal may include an acknowledge (ACK) packet. It should be noted that in step S203, the processing device 14 may start timing after outputting the test packet, and determine whether the response signal is received from the main core network 12 during a default waiting duration. The default waiting duration may be the same as or different from the default duration described in step S109 of FIG. 2, the present disclosure is not limited thereto. In addition, when the processing device 14 determines that the response signal is received from the main core network 12, the processing device 14 may return the test count below to zero.

When the processing device 14 determines that the response signal corresponding to the test packet is received from the main core network 12, the processing device 14 may perform step S201 again to continue monitoring the connection status of the main core network 12. Further, when the processing device 14 determines that the response signal is received from the main core network 12 during the default waiting duration, the processing device 14 may perform step S201 again.

When the processing device 14 determines that the response signal corresponding to the test packet is not received from the main core network 12, the processing device 14 performs step S205. Further, when the processing device 14 determines that the response signal is not received during the default waiting duration, the processing device 14 performs step S205.

In step S205, the processing device 14 accumulates the test count, wherein an initial value of the test count may be 0. Specifically, when the determination result of step S203 is “not”, it means that the test fails, and therefore, the processing device 14 adds 1 to the test count to record the number of failures.

In step S207, the processing device 14 determines whether the test count is equal to or greater than the default count, wherein the default count may be 3, but the present disclosure is not limited thereto. When the processing device 14 determines that the test count is not equal to and is not greater than the default count, the processing device 14 may perform step S201 again to continue monitoring the connection status of the main core network 12. In other words, when the processing device 14 determines that the test count is not equal to and is not greater than the default count, the processing device 14 may perform the test procedure again.

When the processing device 14 determines that the test count is equal to or greater than the default count, the processing device 14 performs step S209 to determine that the main core network 12 is disconnected, that is, the determination corresponds to a situation where the determination result of step S103 in FIG. 2 is “yes”.

In other words, according to the embodiments of FIG. 2 and FIG. 3, the processing device 14 may continue pinging the AMF element of the main core network 12, and trigger the mechanism of lowering the antenna radiated power when determining that the failure count has reached the default count according to the test count.

In view of the above description, through the core network monitoring method and system according to one or more embodiments of the present disclosure, when the main core network experiences a failure, the base station may be triggered to lower antenna radiated power and, after the default duration, increase the antenna radiated power to actively and swiftly respond to the user equipment. This allows for quick triggering of the user equipment to reconnect to the core network, thereby improving the efficiency of overall end-to-end network fault recovery. Further, by using a buffering mechanism of the default duration, the probability of misjudgment by the user equipment may be reduced. In addition, connecting the base station to the backup core network may effectively reduce the time for the user equipment to reconnect to the core network, thereby improving the efficiency of overall end-to-end network fault recovery.

In an embodiment of the present disclosure, the core network monitoring method and system of the present invention may be applied to 5G private network and system composed of 5G small base stations.

What is claimed is:

1. A core network monitoring method, performed by a processing device, comprising:
detecting a connection status of a main core network;
outputting a first control signal to a base station connected to the main core network and starting timing a duration when determining that the main core network is disconnected according to the connection status of the main core network, wherein the first control signal indicates lowering an antenna radiated power of the base station; and
outputting a second control signal to the base station when the duration is equal to or longer than a default duration, wherein the second control signal indicates increasing the antenna radiated power.

2. The core network monitoring method according to claim 1, wherein lowering the antenna radiated power comprises:
turning off an antenna of the base station.

3. The core network monitoring method according to claim 1, wherein detecting the connection status of the main core network comprises:
performing a test procedure, comprising:
sending a test packet to the main core network;
accumulating a test count when determining a response signal corresponding to the test packet is not received; and
determining whether the test count is equal to or greater than a default count;
performing the test procedure again when determining the test count is not equal to and is not greater than the default count, wherein
determining the main core network is disconnected according to the connection status of the main core network is performed when the test count is equal to or greater than the default count.

4. The core network monitoring method according to claim 1, wherein detecting the connection status of the main core network comprises:
using a connection status between the main core network and the base station as the connection status of the main core network.

5. The core network monitoring method according to claim 1, wherein increasing the antenna radiated power comprises:
connecting the base station to a backup core network.

6. A core network monitoring system, comprising:
a main core network;
a base station comprising an antenna and connected to the main core network; and
a processing device connected to the main core network and the base station, the processing device configured to detect a connection status of the main core network, output a first control signal to the base station and start timing a duration when determining that the main core network is disconnected according to the connection status of the main core network, and output a second control signal to the base station when the duration is equal to or longer than a default duration,
wherein the first control signal indicates lowering an antenna radiated power of the antenna, and the second control signal indicates increasing the antenna radiated power.

7. The core network monitoring system according to claim 6, wherein the first control signal indicates turning off an antenna of the base station.

8. The core network monitoring system according to claim 6, wherein
the processing device performs a test procedure, comprising:
sending a test packet to the main core network;
accumulating a test count when determining a response signal corresponding to the test packet is not received; and
determining whether the test count is equal to or greater than a default count;
performs the test procedure again when determining the test count is not equal to and is not greater than the default count, wherein
determining the main core network is disconnected according to the connection status of the main core network is performed when the test count is equal to or greater than the default count.

9. The core network monitoring system according to claim 6, wherein the processing device uses a connection status between the main core network and the base station as the connection status of the main core network.

10. The core network monitoring system according to claim 6, further comprising:
a backup core network, wherein the second control signal comprises an instruction of connecting the base station to the backup core network.
